(19) United States
(12) Patent Application Publication
(10) Pub. No.: US 2008/0313689 A1
(43) Pub. Date: Dec. 18, 2008

(54) INFORMATION PROCESSOR AND INFORMATION PROCESSING METHOD

(76) Inventors: Masato SUZUKI, Yokohama (JP); Hiroki Miyamoto, Fujisawa (JP)

Correspondence Address: MCDERMOTT WILL & EMERY LLP, 600 13TH STREET, N.W., WASHINGTON, DC, 20005-3096, US

(21) Appl. No.: 12/122,073

(22) Filed: May 16, 2008

(30) Foreign Application Priority Data
May 21, 2007 (JP) 2007-133626

(51) Int. Cl. H04N 7/173

(52) U.S. Cl. 725/118

(57) ABSTRACT

For use by a network service such as video distribution in a network, there is provided a device that starts a device in which videos are accumulated. A network start requesting device generates a start-requesting WOL packet that includes information on functions to be started after the system is started and sends the WOL packet to a network start device. When the start-requesting WOL packet is received via the network, the network start device recognizes data, which is added to the WOL packet for starting network service functions, and additionally starts the corresponding network service functions.

### INCORPORATION BY REFERENCE

The present application claims priority from Japanese application JP2007-133626 filed on May 21, 2007, the content of which is hereby incorporated by reference into this application.

### BACKGROUND OF THE INVENTION

1. Field of the Invention

The present invention relates to an information processor that is started remotely and an information processing method for use in a network of multiple terminals. More particularly, the present invention relates to a network start requesting device, a network start device, and a network start method that allow the user to select functions to be started.

2. Description of Related Art

AV(Audio-Visual) network devices capable of sending and receiving contents, such as videos, music, and pictures, via a home network are becoming more popular. In future, user's lifestyles will be established in which the devices on a home network are interconnected to allow the user to receive the contents of a device in the home for playing back on a TV set in a living room or to timer-record a device in some other room via the network. However, when using conventional home electric appliances, the user usually turns off an appliance that is not in use in order to save power. For example, when the user is in the living room, the devices in the bedroom or the study are usually turned off. So, the user who wants to play contents via the network must move to the room, where the device storing the contents is present, and start the device.

Such a situation discourages the user from playing back contents via the network because it is cumbersome to move between rooms to start a device. To solve this problem, there is a need for providing a function to start a device without moving between rooms.

A conventional technology for starting a device via a network is disclosed in JP-A-2002-207752. The general operation of the technology disclosed in JP-A-2002-207752 is as follows. A network start requesting device that requests the start of a device via a network sends a device-starting network packet to a network start device that will be started via the network. On the other hand, upon recognizing that the received network packet is a packet for starting the network start device itself, the network start device turns on the power signal of the whole device system.

### SUMMARY OF THE INVENTION

Because the technology disclosed in JP-A-2002-207752 provides the function only to start the whole system when a device-starting packet is received, the user cannot specify a function the user wants to use. For example, when only the OS(Operating System) is started in response to a device-starting packet, the function to send contents to the network is not started. This requires the user to move to the device to start the function and makes the user feel it inconvenient. Another possible method is to start all functions, which will be required for playing contents via the network, when a device-starting packet is received. However, this method requires times to start all functions and so requires the user to wait for unused functions to be started. It is likely that standard AV home appliances, such as a TV or an HDD recorder that has limited CPU or memory resources, require a long wait time for starting those functions and therefore the user finds this method inconvenient too.

It is an object of the present invention to provide a device that allows the user to specify the start of only the required functions of an AV electric appliance, such as a remote TV or an HDD recorder, via a network.

To solve the above problems, a network start requesting device of the present invention comprises a start table management unit that acquires a MAC address of a device connected to a network and information on a list of functions that can be started; and a WOL packet generation unit that generates a network start packet, which contains a MAC address and information on functions to be started in a system, and sends the start packet to a device to be started. A network start device comprises a WOL packet confirmation unit that recognizes the WOL packet; a power supply management unit that starts a system; a start option management unit that confirms functions to be started after the system is started; and a start function management unit that sends information on a list of functions that can be started and holds information on functions to be started after the system is started.

The network start requesting device acquires a MAC address of a device connected to the network, acquires information on a list of functions that can be started after the system is started and, when a device for which the MAC address and the information on a list of functions have been acquired is used, generates a WOL (Wake On LAN) packet that includes the MAC address and the information on functions to be started after the system is started and sends the WOL packet to the device to be started.

The network start device receives the WOL packet and checks if the MAC address included in the WOL packet is a MAC address thereof and, if the MAC address is a MAC address thereof, starts the system and checks if there is information on functions to be started and, if there is the information on functions to be started, starts the functions to be started after the system is started.

This configuration allows the user to start a desired function also via the network.

The present invention gives the user the network services in the most suitable way.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a network start device in an embodiment.

FIG. 2 is a diagram showing a network start requesting device in the embodiment.

FIG. 3 is a diagram showing an example of the configuration of a network system in the embodiment.

FIG. 4 is a diagram showing a start table in the embodiment.

FIG. 5 is a diagram showing a start option table in the embodiment.

FIGS. 6A and 6B are diagrams showing the display screen of the network start requesting device in the embodiment.

FIG. 7 is a flowchart showing an operation in which information on the network start device is acquired in the embodiment.

FIG. 8 is a flowchart showing an operation in which the network start device is started in the embodiment.

### DESCRIPTION OF THE EMBODIMENTS

Embodiments of the present invention will be described in detail below with reference to the drawings. In the drawings, the same reference numerals or symbols denote the structural elements that have the same function. It should be noted that the present invention is not limited to the embodiments described in the specification. First, before going into the details of the embodiments, the following briefly describes the embodiments in general.

### First Embodiment

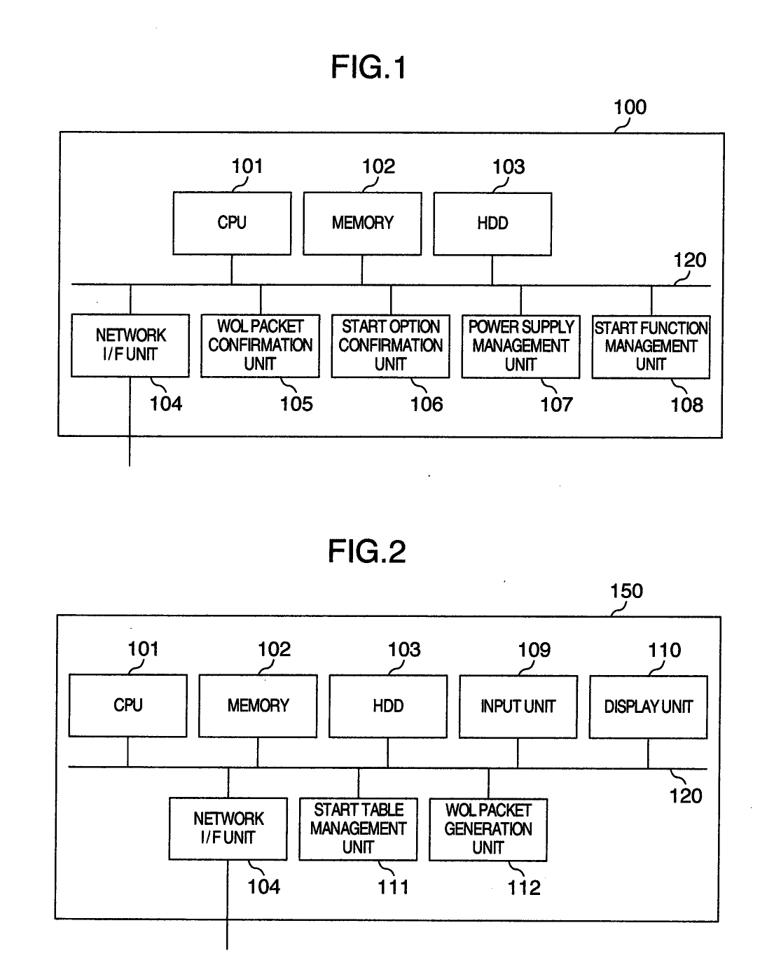

FIG. 1 is a diagram showing a network start device that receives a start request via a network and starts the system, and FIG. 2 is a diagram showing a network start requesting device that sends a start request via the network.

First, the following describes the configuration of the network start device shown in FIG. 1 and the function of its components. A network start device 100 comprises a CPU 101, a memory 102, an HDD 103, a network I/F unit 104, a WOL(Wake On LAN) packet confirmation unit 105, a start option confirmation unit 106, a power supply management unit 107, and a start function management unit 108, all connected to a bus 120.

The CPU 101, memory 102, and HDD 103 have the function to run the OS and the application programs of the network start device 100 and a network start requesting device 150.

When the system is started, the CPU 101, memory 102, and HDD 103 check if additionally started function information is held in the start function management unit 108 and, if it is stored, start the OS and the additionally started functions. There is no limit on the type of OS and application programs; that is, the OS and the applications of the PCs are used when the network start device 100 and the network start requesting device 150 are PCs, the OS and the applications of the TV are used when they are TVs, and the OS and the application of the HDD recorder are used when they are HDD recorders.

The network I/F unit 104 has the function to send and receive data to and from the network. When the system is not started, the network I/F unit 104 sends received packets to the WOL packet confirmation unit 105.

The WOL packet confirmation unit 105 has the function to determine if a packet received by the network I/F unit 104 is a packet for starting this network start device. If the received packet is a packet for starting this network start device (hereinafter called a WOL packet), the WOL packet confirmation unit 105 requests the power supply management unit 107 to start the system and sends the confirmed packet to the start option confirmation unit 106. A typical example of the WOL packet is a magic packet.

The magic packet is composed of six bytes of 0xff followed by 16 MAC addresses of the device to be started. The device that has received the magic packet confirms if the MAC address matches its own MAC address and, if they match, starts the system. In this way, the WOL packet confirmation unit 105 checks if the MAC address owned by the network I/F unit 104 matches the MAC address included in the received magic packet to determine whether to start the system.

The start option confirmation unit 106 has the function to confirm the information on the functions to be additionally started at system startup time. The information on the functions to be additionally started is included in the WOL packet. For example, the magic packet described above can include the information on the additionally started functions after its 16 MAC addresses.

The additionally started function information may have any data structure that is uniquely determined in advance between the network start device 100 and the network start requesting device 150. For example, an ASCII character string or a bit string may be used. Even if a device that cannot interpret the additionally started function receives a WOL packet that includes the additionally started function information, the system can be started because the magic packet is already received.

In addition, because the data following the 16 MAC addresses is determined unnecessary, the additionally started function information causes no inconvenience. When the start option is confirmed, the start option confirmation unit 106 notifies the start function management unit 108 about the additionally started function information and the source network address. It is also possible to include information on multiple additionally started functions and, in this case, the start option confirmation unit 106 notifies the start function management unit 108 about information on all additionally started functions. In addition, upon confirming that the additionally started function information is included, the start option confirmation unit 106 returns the information to the source device to indicate that the additionally started function information has been received.

The power supply management unit 107, which has the function to manage the power of the whole system, turns on the system power in response to a start instruction from the external power button or the WOL packet confirmation unit 105.

The start function management unit 108 has the function to externally send the information on the functions that can be additionally started at system startup time and the function to hold the additionally started function information notified from the start option confirmation unit 106. An example of the actual configuration of the information on the functions that can be additionally added will be described later. The additionally start function information held in the start function management unit 108 is read into the OS and the applications at system startup time and the functions indicated by the additionally started function information are started. In addition, the start function management unit 108 confirms that the additionally started functions have been started and, after confirming that the functions have been started, sends a notification to the source device that the functions have been started.

Next, the following describes the configuration of the network start requesting device shown in FIG. 2 and the function of its components.

The network start requesting device 150 comprises a CPU 101, a memory 102, an HDD 103, a network I/F unit 104, an input unit 109, a display unit 110, a start table management unit 111, and a WOL packet generation unit 112, all connected to a bus 120.

The input unit 109 has the function used by the user to operate the network start requesting device. For example, in the case of a TV, the input unit 109 receives an operation on a remote control and gives an instruction to an application that is started according to the operation.

The display unit 110 has the function to display videos output by the user via the network start requesting device. For example, in the case of a TV, the display unit 110 can display videos and menus.

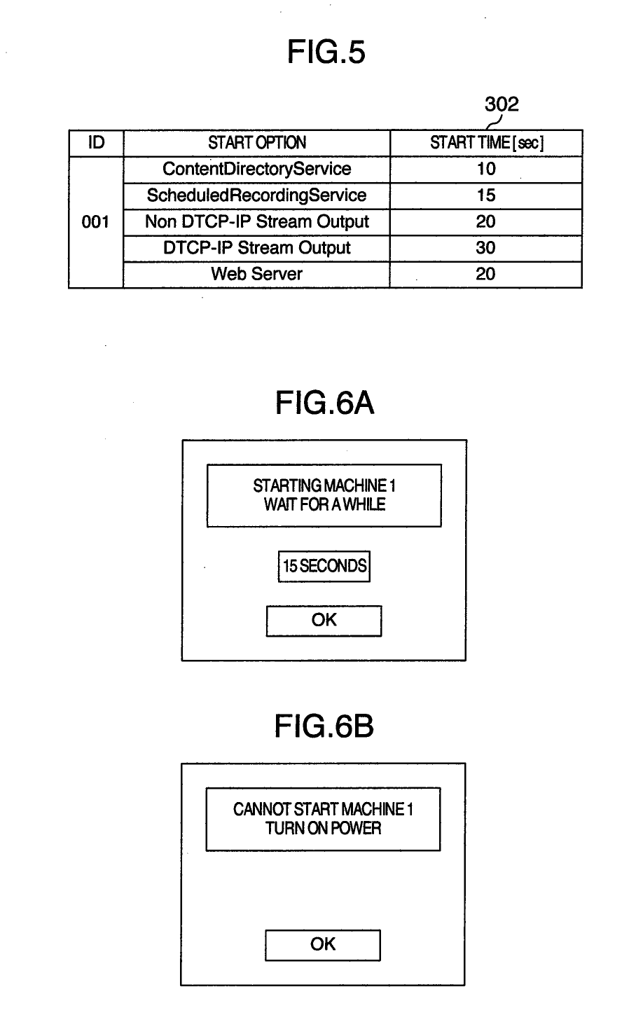

The start table management unit 111 has the function to create, maintain, and manage the tables for managing the devices that can be started via the network. The management tables for managing the devices that can be started via the network have the configurations shown in FIG. 4 and FIG. 5.

First, the following describes the table shown in FIG. 4. FIG. 4 shows a start table 301 containing a list of devices that can be started via the network. In this embodiment, the start table 301 in a system that employs UPnP(Universal Plug and Play) is used. The start table 301 contains the following items for each device to be started via the network: the management ID that is managed internally in the network start requesting device and the UDN, the MAC address, the presence/absence of start options, and the Friendry Name of the device to be started. In the UPnP architecture, it is possible to uniquely identify a device using a device-specific ID called UDN, which can be acquired by accessing the device description of the device that operates as a UDN server.

So, in the UPnP network, a device to be started must be managed not by the MAC address but by the UDN. On the other hand, because a WOL packet is usually a magic packet, the UDN and the MAC address are paired in the start table 301. The UDN and the MAC address can be paired by acquiring the UDN of a target device when accessing the device description and by acquiring the MAC address from the IP address via ARP.

The Friendry Name, which is the nickname of a device used by UPnP, cannot be defined uniquely for each device but is information the user can understand easily. So, the Friendry Name, if used as information displayed on the user interface, can increase the user convenience.

The Friendry Name can be acquired in the same way the UDN is acquired. The presence/absence of start options, which indicates whether there are functions that can be additionally started, can be acquired from the start function management unit 108 of the network start device 100 via the network. For example, UPnP allows vendor-specific services to be configured, a service that sends and receives additionally started function information can be configured by the network start device 100 and the network start requesting device 150.

The information on an ID in the start table 301 is added each time a device is added to the network. On the other hand, an ID is deleted when the server device is not accessed, or no connection notification is sent from the server device, for a predetermined time.

FIG. 5 shows detailed information on the options when the presence/absence of start options in the start table 301 indicates that the start options are present. A start option table 302, which is the start option table of ID 001 in the start table 301, comprises a list of functions that can be additionally started and the time required to start each function. The functions that can be additionally started are any functions including UPnP services such as ContentDirectoryService and ScheduledRecordingService, the video output function of copyright protected or unprotected objects, and web server function for accessing web pages. The information on an ID is added to the start option table 302 each time a device is added that includes functions that can be additionally started. On the other hand, an ID is deleted at the same time the corresponding ID is deleted from the start table 301.

The WOL packet generation unit 112 has the function to generate a WOL packet that is sent to the network start device 100. A WOL packet is generated by referencing the start table 301 and the start option table 302 managed by the start table management unit 111. For example, to start ScheduledRecordingService of the device with ID 001 registered in the start table 301, a magic packet is first generated from the MAC address described in the start table 301 and, after that, information indicating that ScheduledRecordingService is additionally started is added to the end of the magic packet to generate a WOL packet. The generated WOL packet is output to the network via the network I/F unit 104.

Next, the following describes the flow of the device start operation that is performed between the network start device 100 and the network start requesting device 150 via the network.

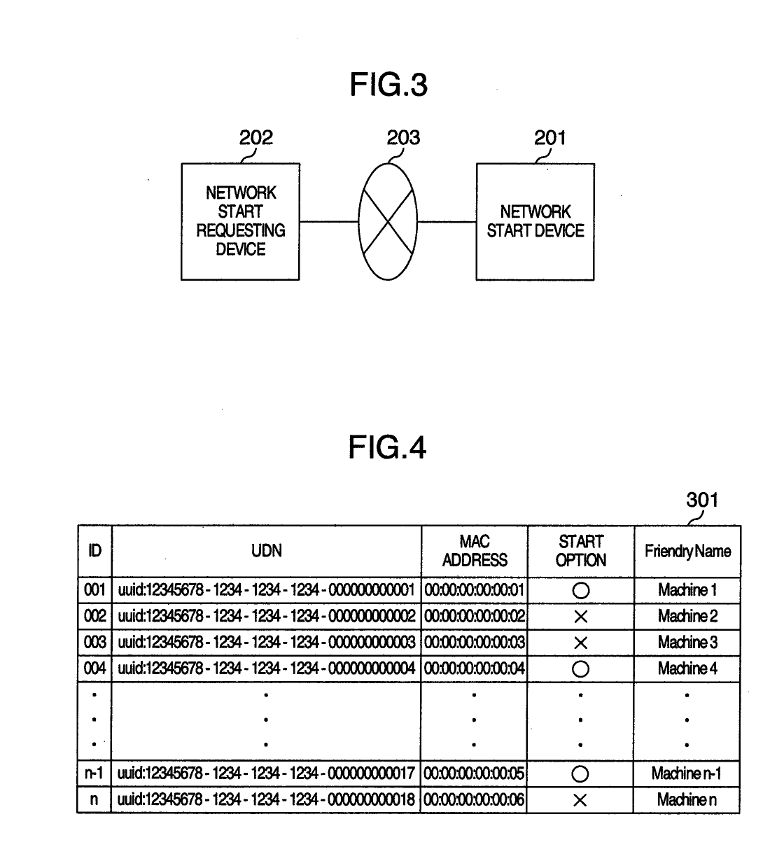

FIG. 3 is a diagram showing the connection between the network start device 100 and the network start requesting device 150. Referring to FIG. 3, a network start device 201 and a network start requesting device 202 are connected to a network 203.

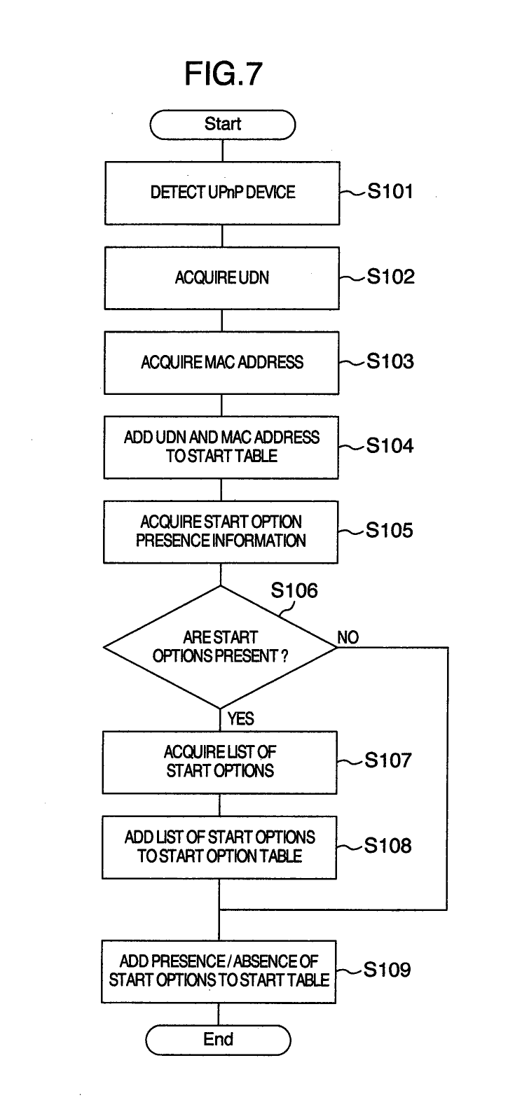

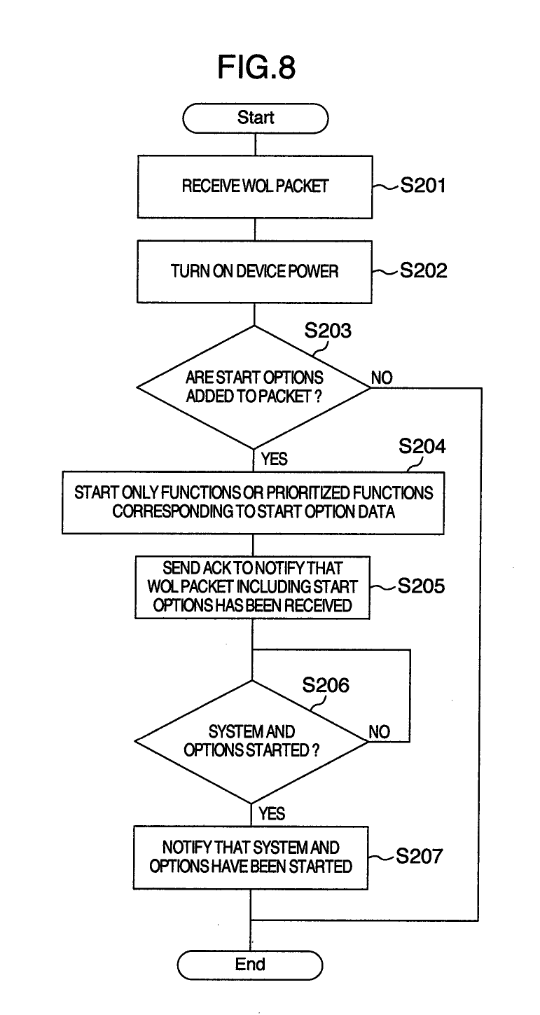

Assume that a device is started via the network between the network start device 201 and the network start requesting device 202. The procedure for starting a device via the network is divided into the flow of acquiring device information on the device to be started and the flow of starting the device by a WOL packet via the network. FIG. 7 shows the former operation flow, and FIG. 8 shows the latter operation flow.

First, with reference to FIG. 7, the following describes the operation flow for the network start requesting device 202 to acquire information on a device to be started. The network start requesting device 202 receives a network connection notification from a network start device connected to the network to which the network start requesting device 202 is connected (S101).

Next, the network start requesting device 202 acquires the device description on the network start device that has issued the network connection notification and acquires the UDN (S102).

Next, the network start requesting device 202 acquires the MAC address from the IP address, which was accessed to acquire the device description, via APR (S103). Because a pair of the UDN and the MAC address is acquired in S102 and S103, the network start requesting device 202 registers the UDN and the MAC address in the start table 301 (S104).

Next, the network start requesting device 202 acquires the information indicating whether the network start device that has issued the network connection notification has the functions that can be additionally started (S105). If the network start device has the functions that can be additionally started (S106), the network start requesting device 202 acquires a list of additionally started functions from the network start device that has issued the network connection notification (S107).

The list of acquired additionally started functions is added to the start option table 302 (S108). After adding the list of additionally started functions to the start option table 302, the presence/absence of start options is registered in the start table 301 to indicate that the start options are present (S109). On the other hand, if the functions that can be additionally started are absent (S106), the presence/absence of start options is registered in the start table 301 to indicate that the start options are absent (S109).

By doing so, the network start requesting device 202 can acquire information for starting the network start device via the network. In addition, when the network start device has the functions that can be additionally started, the network start requesting device 202 can acquire a list of functions that can be additionally started and send a WOL packet to the network start device.

Next, with reference to FIG. 8, the following describes the operation flow for the network start device 201 to start the system when a WOL packet is received.

The network start requesting device 202, which has acquired device information on devices to be started by the operation flow in FIG. 7, sends a WOL packet to the network start device 201. In the description below, assume that the WOL packet that is sent contains ScheduledRecordingService as the additionally started function of the device with ID 001 registered in the start table 301 as in the example described above.

When the WOL packet is received (S201), the network start device 201 confirms if the MAC address is its own MAC address and, if so, turns on its power (S201).

Next, the network start device 201 confirms the data string stored at the end of the received WOL packet and checks if there are functions to be additionally started (S203). If there are functions to be additionally started, the network start device 201 starts the functions to be started additionally after the system is started (S205).

Next, the network start device 201 confirms that the system and the additionally started functions have been started (S206) and, after they have been started, sends a notification to the network start requesting device to notify that they have been started (S207).

By performing the operation described above, the network start device 201 can start the system and the functions to be additionally started based on the received WOL packet and can use the desired network functions without pressing the power button on the server device.

Next, with reference to FIGS. 6A and 6B, the following describes the display screen of the network start requesting device 202 that is displayed when a device is started via the network.

FIGS. 6A and 6B show the display screens of the network start requesting device 202 when ScheduledRecordingService of the device with ID 001, registered in the start table 301, is started. FIG. 6A is the display screen displayed when the WOL packet is sent to the network start device 201. On this screen, that the device with ID 001 is being started is shown using the Friendry Name of ID 001. In addition, the start option table 302 is referenced to acquire that the start time of ScheduledRecordingService is 15 seconds, and the countdown of 15 seconds is displayed.

This display notifies the user about the start time via the network. FIG. 6B shows the display screen after 15 seconds have elapsed. If the device cannot be started for some reason after the time described in the start option table 302 has elapsed, the message is displayed to prompt the user to turn on the power. The messages displayed as described above allow the user to start the device smoothly via the network. Although the message prompting the user to turn on the power is displayed in this embodiment, the message indicating the possibility of a network error may also be displayed.

### Second Embodiment

Another embodiment will be described. This embodiment differs from the first embodiment in the way the network start device 201 starts the system. In the first embodiment, the network start device 201 starts the system and, in addition, additionally starts the functions described in the start option table 302. In contrast, in this embodiment, all functions described in the start option table 302 are started when the system is started.

In this case, when a WOL packet is received, the network start device 201 acquires the information on the additionally started functions and starts the additionally started functions before other functions with the highest priority given to them. For example, when ScheduledRecordingService is an additionally started function, the network start device 201 first starts the system, starts ScheduledRecordingService and, after that, starts the remaining functions.

The operation described above allows the user to use the desired network functions as soon as possible.

It should be further understood by those skilled in the art that although the foregoing description has been made on embodiments of the invention, the invention is not limited thereto and various changes and modifications may be made without departing from the spirit of the invention and the scope of the appended claims.

1. An information processor comprising:
a WOL packet confirmation unit that recognizes a start packet received via a network;
a power supply management unit that starts a system;
a start option management unit that confirms functions to be started after the system is started; and
a start function management unit that sends information on a list of functions that can be started and holds information on functions to be started after the system is started,
wherein said information processor receives a start packet and checks if the start packet contains a MAC address thereof and, if the start packet contains a MAC address thereof, starts the system and checks if there is information on functions to be started and, if there is the information on functions to be started, starts the functions to be started after the system is started.

2. An information processor comprising:
a start table management unit that acquires a MAC address of a device connected to a network and information on a list of functions that can be started; and
a WOL packet generation unit that generates a start packet, which contains a MAC address and information on functions to be started in a system, and sends the start packet to a device to be started,
wherein said information processor acquires a MAC address of a server device connected to the network, acquires information on a list of functions that can be started after the system is started and, when a device for which the MAC address and the information on a list of functions have been acquired is used, generates a start packet that includes the MAC address and the information on functions to be started after the system is started and sends the start packet to the server device to be started.

3. An information processing method,
wherein a client device acquires a MAC address of a server device connected to a network and information on a list of functions that can be started after a system is started and, when the device for which the MAC address and the information on a list of functions have been acquired is used, generates a start packet, which contains the MAC address and the information on functions to be started after the system is started, and sends the start packet to the server device to be started, and
wherein a server device receives the start packet and checks if the MAC address in the start packet is a MAC address thereof and, if the MAC address is a MAC address thereof, starts the system, checks if there is information on functions to be started and, if there is information on functions to be started, starts the functions to be started after the system is started.
